(19) United States
(12) Patent Application Publication
(10) Pub. No.: US 2021/0063021 A1
(43) Pub. Date: Mar. 4, 2021

(54) FILTERS, MOUNTS AND METHODS OF MOUNTING FILTERS

(71) Applicant: Restaurant Technologies, Inc., Mendota Heights, MN (US)

(72) Inventor: Jordan Salpietra, Dallas, TX (US)

(21) Appl. No.: 16/950,388

(22) Filed: Nov. 17, 2020

Related U.S. Application Data
(63) Continuation-in-part of application No. 15/927,245, filed on Mar. 21, 2018.
Application No. 15/927,245 is a continuation-in-part of application No. 15/072,063, filed on Mar. 16, 2016, now abandoned.
Application No. 15/072,063 is a continuation-in-part of application No. 14/304,765, filed on Jun. 13, 2014, now Pat. No. 9,555,356.
(60) Provisional application No. 62/133,987, filed on Mar. 16, 2015.
(60) Provisional application No. 61/835,383, filed on Jun. 14, 2013.

(51) Int. Cl. F24C 15/20; B01D 50/00

(52) U.S. Cl. CPC F24C 15/2035; B01D 45/08; B01D 50/002

(57) ABSTRACT

A grease filter comprises an external frame, a baffle filter, and a first housing element. The external frame defines a pathway for airflow therethrough and partially defines an upstream portion of the grease filter and a downstream portion of the grease filter. The baffle filter is disposed within the downstream portion of the grease filter and secured within the external frame. The first housing element is positioned within the upstream portion of the grease filter and is configured to provide support to a filter pad to maintain the filter pad in a generally flat configuration.

### CROSS-REFERENCE TO RELATED APPLICATIONS

This application is a continuation-in-part of U.S. non-provisional application Ser. No. 15/927,245, filed Mar. 21, 2018, which claims priority to U.S. non-provisional application Ser. No. 15/072,063, filed Mar. 16, 2016, which claims priority to U.S. provisional application Ser. No. 62/133,987 filed on Mar. 16, 2015, and which is a continuation-in-part of Ser. No. 14/304,765, filed Jun. 13, 2014, which in turn claims priority to U.S. provisional application Ser. No. 61/835,383, filed Jun. 14, 2013, the disclosures of all of the above being hereby incorporated by reference in their entireties.

### FIELD OF THE INVENTION

The present invention relates generally to filters for use in exhaust hoods.

### BACKGROUND

In a typical restaurant kitchen, a plurality of cooking units are lined up side by side in a row under common exhaust hoods. The cooking units may include, for example, ranges, griddles, fryers, and broilers. The cooking processes performed on such equipment all produce air laden with grease, smoke, fumes, moisture, heat, and other particles in varying amounts and temperatures. The air is drawn in to the exhaust hood, where it is filtered. One known filtration system is disclosed in U.S. Pat. No. 7,581,539 B2 to Aviles at al., the disclosure of which is hereby incorporated by reference.

### BRIEF SUMMARY

According to one embodiment, a grease filter includes an external frame, a baffle filter, a first housing element, and a second housing element. The external frame includes a plurality of drain holes and at least two hinge barrels. The external frame defines a pathway for airflow therethrough and partially defines an upstream portion of the grease filter and a downstream portion of the grease filter. The baffle filter is disposed within the downstream portion of the grease filter and is secured within the external frame. The first housing element is positioned within the upstream portion of the grease filter and includes a plurality of perforations, a viewport, and at least two coupling devices. The first housing element is configured to provide support to a filter pad to maintain the filter pad in a generally flat configuration. Each coupling device includes a hinge pin configured to engage at least one of the hinge barrels of the external frame. The second housing element is disposed in series with the first housing element and positioned, within the external frame, adjacent to the baffle filter. The second housing element includes a plurality of perforations and a non-perforated region, wherein: the non-perforated region is in at least partial alignment with the viewport of the first housing element; and the second housing element is held in spaced relation from the baffle filter by one or more divider tabs.

According to another embodiment, a grease filter includes an external frame, a first housing element, and a second housing element. The external frame defines a pathway for airflow therethrough and partially defines an upstream portion of the grease filter and a downstream portion of the grease filter. The first housing element is disposed within the external frame and includes a viewport and at least one coupling device configured to engage one or more hinge barrels of the external frame. The second housing element is disposed within the external frame and in series with the first housing element. The second housing element includes a non-perforated region that is in at least partial alignment with the viewport of the first housing element.

According to yet another embodiment, a grease filter includes an external frame, a baffle filter, and a first housing element. The external frame defines a pathway for airflow therethrough and partially defines an upstream portion of the grease filter and a downstream portion of the grease filter. The baffle filter is disposed within the downstream portion of the grease filter and secured within the external frame. The first housing element is positioned within the upstream portion of the grease filter and is configured to provide support to a filter pad to maintain the filter pad in a generally flat configuration.

Technical advantages of certain embodiments may include presenting a visual indicator of usable life of filter material disposed in a filter assembly. Being able to determine the usable life of filter material may, in some cases, reduce waste of filter material that still has usable life. In other cases, determining the usable life of filter material may signal an operator to dispose of/replace filter material that has no usable life left. This may be advantageous given that continued use of a filter material having no usable life may increase fire risk and/or air flow resistance. Another technical advantage of embodiments disclosed herein is the increased percent openness of perforated metal sheets as compared to standard, unmodified perforated metal. This disclosure recognizes that incorporating such improved perforated metal sheets in a filter assembly may provide significant air flow advantages and/or facilitate the reveal of a visual indicator on filter material. Yet another technical advantage that may be realized by embodiments disclosed herein is the ease of installation, removal, and cleaning as compared to conventional grease filters. Other technical advantages will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the embodiments of the present invention, needs satisfied thereby, and the objects, features, and advantages thereof, reference now is made to the following description taken in connection with the accompanying drawings.

FIG. 1 is a perspective view of filter assemblies mounted in an exhaust hood above a cooking apparatus, according to an embodiment of the invention.

FIG. 2 is a perspective view of a filter assemblies being lifted by a mounting tool into an opening in the exhaust hood, according to an embodiment of the invention.

FIG. 3 is perspective view of the components of the filter assembly with the external support structure removed and the filter material folded back inside of the opening within the second filter, according to an embodiment of the invention.

FIG. 4 is a front isometric view of the filter assembly, according to the embodiment of the invention.

FIG. 5 is a schematic cross-sectional view of the filter assembly, according to an embodiment of the invention.

FIG. 6 is a back isometric view of the filter assembly, according to an embodiment of the invention.

FIG. 7 is an enlarged front view of the first filter, according to an embodiment of the invention.

FIG. 8 is perspective view of the bottom of the filter assembly, according to an embodiment of the invention.

FIG. 9 is an exploded perspective view of the filter assembly, according to an embodiment of the invention.

FIG. 10 is an exploded perspective view of the filter assembly, according to an embodiment of the invention.

FIG. 11A is an exploded view of a filter assembly that includes filter material, according to certain embodiments of the invention.

FIG. 11B is a perspective view of the filter assembly of FIG. 11A, according to certain embodiments of the invention.

FIG. 12 illustrates the filter material of FIG. 11A at various stages of its life cycle, according to certain embodiments of the invention.

FIG. 13 illustrates an exploded view of a decal assembly, according to certain embodiments of the invention.

FIG. 14A illustrates a front view of a grease filter, according to certain embodiments of the invention.

FIG. 14B illustrates a cross section of the grease filter of FIG. 14A assembled to include filter material, according to certain embodiment of the invention.

FIG. 15 illustrates a perspective view of the grease filter of FIG. 14, according to certain embodiments of the invention.

FIG. 16 illustrates a side view of the grease filter of FIG. 14, according to certain embodiments of the invention.

FIG. 17 illustrates an exploded, perspective view of a grease filter assembly comprising the grease filter of FIG. 14 and filter material, according to certain embodiments of the invention.

### DETAILED DESCRIPTION

Commercial exhaust hoods manufactured to be installed in the U.S. must comply with certain codes and standards, such as the National Fire Protection Associates (NFPA) Standard 96. This standard requires that all hoods used in commercial cooking establishments that are installed over cooking equipment that creates effluents other than heat and steam, such as grease, during the cooking process include grease removal devices that are individually listed in accordance with Underwrites Laboratories (UL) Standard 1046, or as components of UL 710 listed hoods. This standard requires grease removal devices to be able to prevent the spread of fire from the upstream face of the filter to an area downstream of the filter.

Since standard exhaust hoods have a two inch wide filter channel for the standard two inch thick baffle filters, other embodiments of disposable grease filters that are fiber based may require welding or drilling to modify the exhaust hood and/or existing baffle filters since there is no space within the filter channel to fit the additional disposable grease filter adjacent the baffle filters.

Example embodiments of this disclosure include a multi-staged grease filtration system designed to completely fit inside of a standard two inch wide baffle filter channel in a ventilation hood including a first filter with high efficiency grease filtration capabilities, and at least one second filter located downstream (with respect to the direction of air flow through the filter and hood) of the first filter. The first filter includes filter material attached to an external support structure that is made of relatively more rigid material. The second filter is preferably effective at preventing the spread of fire from the upstream face of the filtration system to an area downstream of the system.

The second filter may be any filter that drains grease out of the filter, and is preferably also an effective fire barrier. One example of a filter for a ventilation hood that drains grease to a grease drain and is an effective fire barrier is a baffle-type filter, such as that disclosed in U.S. Pat. No. 3,910,782 to Struble et al, the disclosure of which is hereby incorporated by reference.

It is understood that other grease-draining and fire barrier filters are within the spirit and scope of the embodiments of the present disclosure.

A baffle filter is very effective at preventing fire from traveling downstream as required by UL Standard 1046. However, while the baffle filter is satisfactory at filtering out grease with a particle size of greater than about 10 micrometers (μm), but it is less effective with smaller particles. Therefore, embodiments of the present invention further include a first disposable or permanent filter, located upstream of the second filter in the airflow direction, the second filter being separate to the first filter. Moreover, baffle filters are difficult to clean and re-use so it is beneficial to have a disposable filter upstream from the baffle filter.

In particular embodiments, the filter material is made, in whole or in part, of fibers, such as natural, synthetic, and/or hybrid fibers, with or without a stabilizer frame, such as, for example and without limitation, the filter disclosed in U.S. Pat. No. 8,277,530 B2 to Alexander et al., the disclosure of which is hereby incorporated by reference. In other embodiments, the filter material is made, in whole or in part, of wool fiber, such as, for example and without limitation, the filter disclosed in U.S. Pat. No. 6,293,983 to More, the disclosure of which is hereby incorporated by reference.

A recent change in the UL 1046 standard now allows for testing of so-called “multi-stage” filters. Materials that cannot and could not pass the fire safety requirement of the standard individually may be utilized if the filter assembly as a whole can pass the tests mandated by the standard.

Embodiments of the present disclosure thus provide a filtration system with both a first filter and a second filter, in which the second filter is a very effective fire barrier, and the first filter is very effective at entrapping particulates. The resulting combination provides superior performance in both respects, while simplifying the installation procedure and reducing the renewable costs associated with disposable filter material.

In some embodiments, the first filter is made, in part, of metal mesh or fibers, such as natural, synthetic, and/or hybrid fibers, such as, for example and without limitation, wool fibers, wood-based viscose fibers, and cellulose-based synthetic fibers. The blend of fibers may include blending wool fibers with flame resistant viscose fibers; carding the blend into a fiber web; spraying the fiber web with a binder; needle punching the fiber web into a non-woven blanket; and applying a bonding emulsion to the wool fibers. Particular embodiments may further comprise applying a vacuum to the non-woven blanket and/or passing the non-woven blanket through an oven at over 280 degrees Fahrenheit. In some embodiments, the first filter is made of organic material, such as natural organic material. In some embodiments, the second filter is made of animal-derived organic material, such as wool.

Other filter materials are within the scope of the appended claims.

The material of the first filter may be disposed adjacent to or attached to an external support structure made of relatively more rigid material. While fiber filters are advantageous for their particle filtration abilities, their rigidity is similar to that of paper towels if an internal frame, or an external housing that sandwiches the filter material between two surfaces, is not present. Internal frame options result in expensive manufacturing costs, while a sandwiching external housing that sandwiches the filter material between two surfaces compresses the filter material resulting in less grease loading capabilities while increasing airflow resistance. For this reason, their use is limited despite their filtration properties.

By attaching a single surface of the fiber material to one surface of an external support structure, the drawbacks caused by the fiber material's lack of rigidity may be rectified. In a particular embodiment, the external support structure may contain fastening elements that grip the filter material to hold it in place. In this way, the material may gain rigidity for easier installation and removal, while mounting its original loft, density, grease loading abilities and minimal airflow resistance.

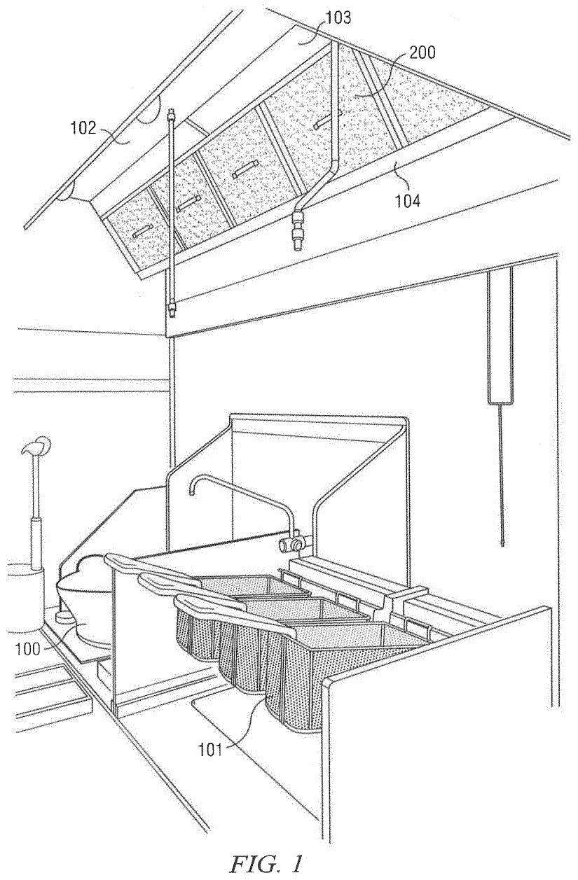

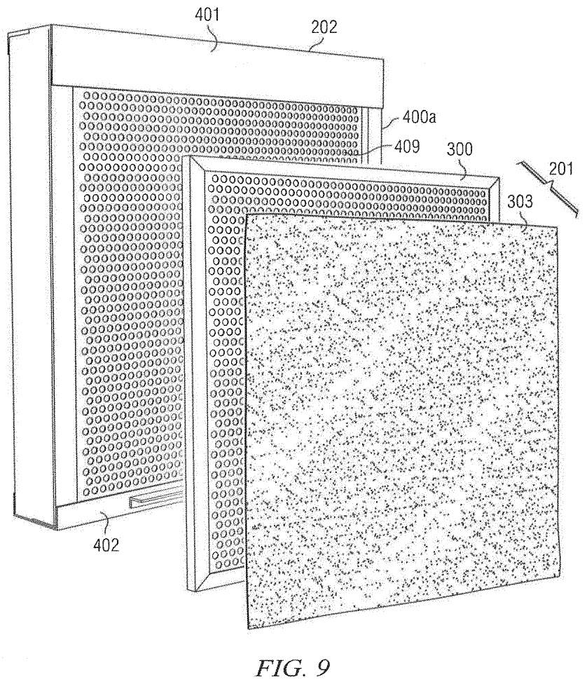

As set forth above, the first filter may be installed upstream of the second filters in an exhaust hood canopy according to a particular embodiment, as depicted in FIG. 1. There are at least two alternative configurations for positioning the first filter with respect to the external support structure. First, the first filter may be positioned with the filter material on the downstream side of the external support structure in an airflow direction, similar to those depicted in FIG. 8. Second, the first filter may be positioned with the filter material on the upstream side of the external support structure similar to those depicted in FIG. 9. The additional benefit when the external support structure is positioned on the upstream side of the filter material would be that the external support structure would provide better aesthetics over the appearance of a soiled filter material. Alternatively, when the external support structure is configured on the downstream side of the filter material, the external support structure would remain cleaner for longer periods of time which results in reduced labor and associated cleaning costs.

As depicted in FIG. 1, the filter assemblies 200 mounted within a hood 102 over cooking equipment 100. A fryer 101 is illustrated for exemplary purposes. Alternatively, the cooking equipment may include, for example, ranges, griddles, fryers, broilers, or the like.

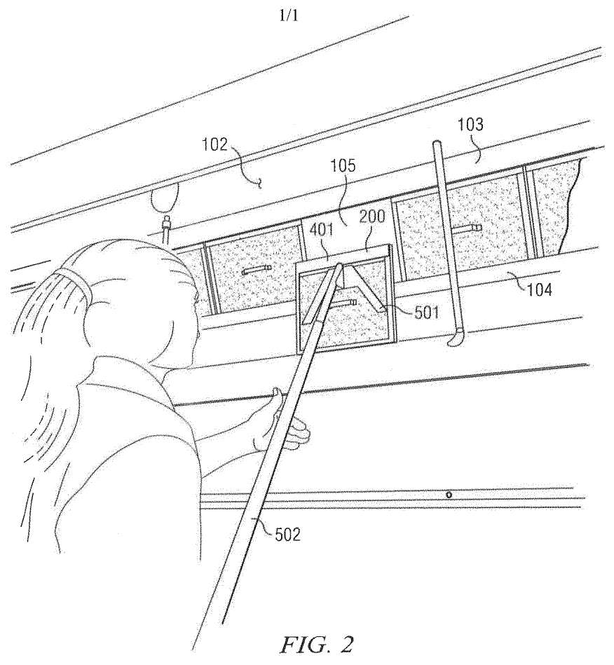

FIG. 2 depicts a filter assembly 200 being lifted by sliding the head 501 of a mounting tool 502 under the top lip 401 of the filter assembly 200, and maneuvering the filter assembly up into the an opening 105 and top channel 103 within the hood 200 where it will rest down into the bottom channel 104.

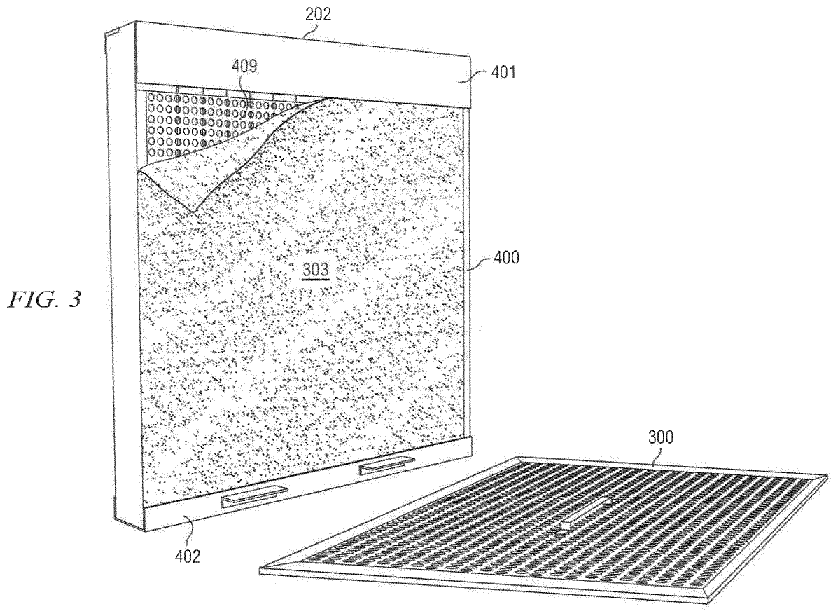

FIG. 3 shows the exterior support structure 300 removed from the housing 400, while the filter material 303 has been inserted behind the top lip 401 and bottom lip 402 of the second filter 202. The filter material 303 has been folded back to reveal the downstream perforated air diffuser 409.

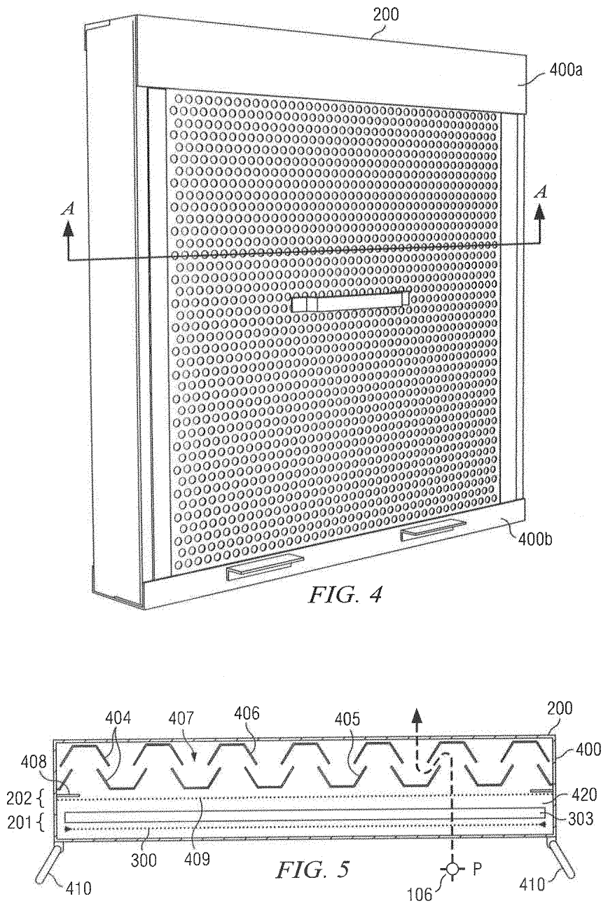

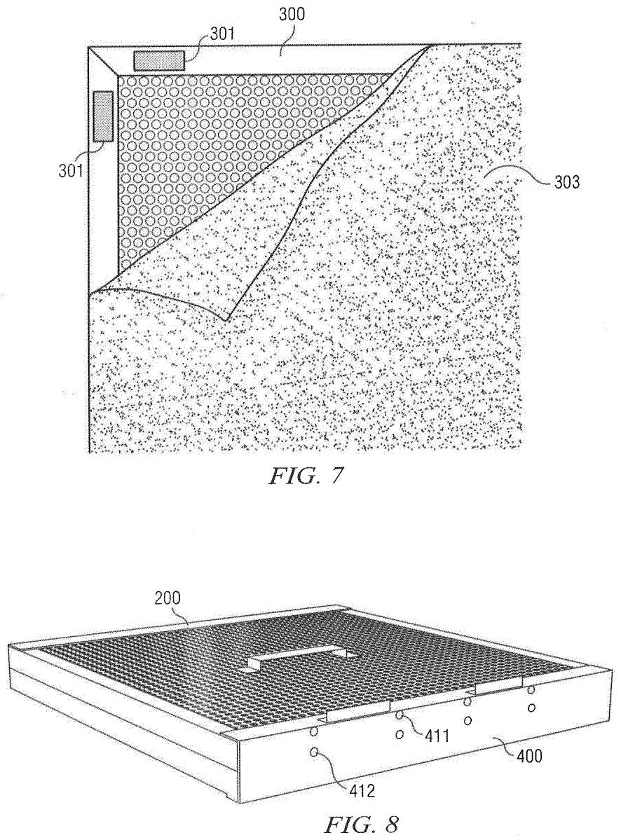

FIG. 4 shows a front isometric view of the filter assembly 200 and a reference line used to indicate a cross-sectional view as depicted in FIG. 7.

FIG. 5 illustrates one of the cross-section views of the filter assembly 200 that was referenced in FIG. 4, wherein the filter assembly 200 may include the following components: a first filter 201 and a second filter 202. The first filter 201 may include an exterior support structure 300 and filter material 303. The second filter 202 may include middle divider tabs 408 (optional), a perforated air diffuser 409, and a baffle assembly 404 all enclosed within the housing 400. The baffle assembly 404 by comprise of an upstream row of vertical baffle ribs 405 and a downstream row of vertical baffle ribs 406, each being offset from the other to define an airflow spacing 407. Optional vertical bail handles 410 may be added to the housing 400. The filter assembly 200 may define tortuous paths “P” 106 that may enter the filter assembly 200 via the first filter 201, then through the perforated air diffuser 409, then through the airflow spacing 407 provided by the baffle assembly 404.

The majority of the grease may be filtered from the airflow by the filter material 303 within the first filter 201. Any remaining grease carried in passing air may adhere to upstream row of vertical baffle ribs 405 and a downstream row of vertical baffle ribs 406. Thereafter, baffles assembly 404 may function as a channel, or gutter, and direct the accumulation of grease under the force of gravity to the bottom of the filter assembly 200 as further described in FIG. 8

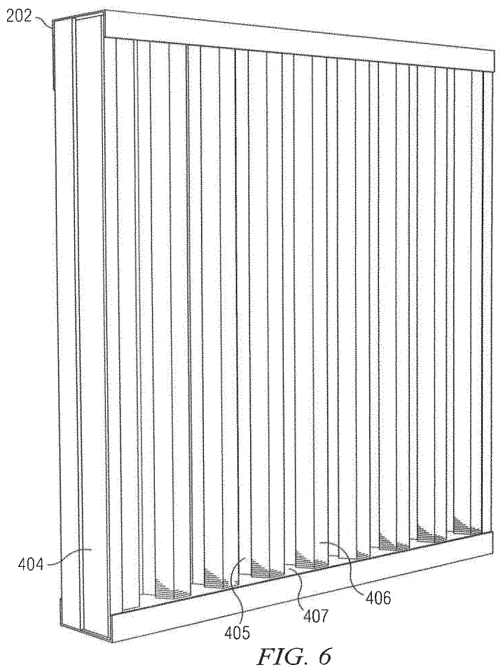

FIG. 6 shows the back side of the second filter 202 revealing a baffle filter assembly 404 comprising of a upstream row of vertical ribs 405, a downstream row of vertical ribs 406 and airflow openings 407.

The embodiments of FIGS. 4-6 may be configured such that the baffle assembly 404 and the perforated air diffuser 409 are fixed within housing 400, and the exterior support structure 300 and filter material 303 are removable from housing 400. This allows the filter material to be replaced periodically, without having to remove the entire housing from the kitchen hood. The filter material 303 may simply be placed against the exterior support structure 300 and then the exterior support structure inserted within the housing 400. Upper lip 400a and lower lip 400b of housing 400 hold exterior support structure 300 in place within housing 400.

When installed in this manner within hood 102, gravity will pull exterior support structure 300 away from diffuser 409 such that the filter material will not be compressed between diffuser 409 and exterior support structure 300. This allows for an air gap 420 between filter material 303 and diffuser 409. This air gap and the lack of compression of filter material 303 allows filter material 303 to operate more efficiently at removing grease particulates from the air. Removable exterior support structure may also be perforated to allow for sufficient air flow there through.

In the illustrated embodiment, upper lip 400a is approximately 2″ but may be between 1″ and 3″ in order to secure the exterior support structure in place. Similarly, lower lip 400b is approximately 1″ but could be between 0.05″ and 1.5″ in order to secure the exterior support structure in place. Since the overall height of the housing is approximately 15.5″ and the overall height of the exterior support structure is approximately 14.5″, the exterior support structure easily fits within the housing and lips 400a and 400b hold it in place.

In the illustrated embodiment, the thickness of the exterior support is approximately 0.25″ but could be within a range of 0.15″ to 0.5″. The filter material (e.g., filter pad) is approximately 0.125″ thick but could be within a range of 0.1″ to 0.4″ within the teachings of the disclosure.

FIG. 7 shows an embodiment of this invention where the filter material 303 is attached the exterior support structure 300 with the use of independent fastening elements 301 which can be located on any one or more sides of the external support structure 300, and are designed like velcro or hooks to adhere or penetrate directly to the filter materials 303 woven or nonwoven surface. The fastening elements 301 can be any size or shape, and attached to external support structures 300 using either adhesive, welding, riveting, sewing, screwing or any combination thereof.

Other independent fastening elements 301 are within the scope of the appended claims. For example, in particular embodiments, the filter material may be attached to the external support structure using clasps, hook and loop fasteners, clamps, adhesive, stick tacks, hooks or other similar means.

FIG. 8 shows the bottom of the housing 400 of the filter assembly 200 which may comprise of a series of drainage apertures 411 and 412, for the first filter and second filter respectively, through which the grease may travel on its way to a ventilation hoods holding reservoir (not shown).

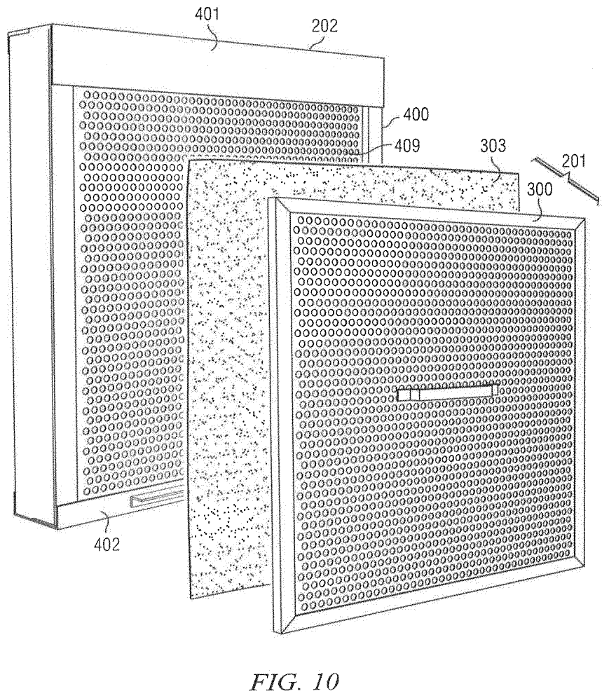

FIGS. 9-10 show two configuration options in which the first filter 201 is placed in the upstream of a second filter 202.

FIG. 9 shows that within the first filter 201, the external support structure 201 is oriented downstream of the filter material 303. This may be done so that the filter material 303 filters the air before it come into contact with the external support structure 300, reducing the need for the external support structure 300 to be cleaned nightly and still giving rigidity to the filter material 303.

FIG. 10 shows that within the first filter 201, the external support structure 201 is oriented upstream of the filter material 303. This may be done so that the external support structure 300 offers better aesthetics while maintaining rigidity to the filter material 303. This configuration is further illustrated in the embodiment of FIGS. 1-5.

In accordance with a particular embodiment of the present invention, components of the filter assembly may be made from stainless steel. For example, re-usable components of the system including the baffle assembly, air diffuser, housing and exterior support structure may be made of stainless steel. The filter material that comprises the disposable filter may be made from a variety of different materials, including a combination of wool and viscose materials. In certain embodiments, it is advantageous to have wool comprise more than 50% and in some cases more than 75% of the blend of materials of the filter material. For example, wool may account for 60% to 90%, or 70% to 80% of the blend. In such embodiments, viscose may be the only other material in the blend and account for the balance of the material. In other embodiments, it is more advantageous to include more than 50% and in some case more than 75% of viscose material in the blend. Similarly, viscose may comprise 60% to 90%, or 70% to 80% of the blend. In such embodiments, wool may be the only other material in the blend and account for the balance of the material.

It is advantageous to size the filter assembly to allow it to be inserted into a hood to replace a two inch baffle filter. Accordingly, the thickness of the housing and in some embodiments the entire filter assembly may be within the range of one and one-half to two inches thick. In certain embodiments, in order to allow the best “fit” within the hood, the total thickness would be within a range of 1.65″ to 1.95″. In certain illustrated embodiment herein, a 1.75″ thick assembly is illustrated.

In particular embodiments, the filter assembly of FIGS. 4-6 may be a square configuration with sides of a length within a range of 14″ to 16″. This would allow the multi-stage filter to replace a standard baffle filter in a standard hood. In the illustrated embodiment, the sides of the filter are approximately 15.5″ long.

In order to fit within the housing of the filter assembly, the exterior support structure is configured to be a square or rectangular configuration that is slightly smaller than the filter assembly. In the illustrated embodiment, the exterior support structure is approximately 14.5″ by 15″. The “short” side corresponds to the side that will engage the top and bottom lips of the housing. In other embodiments, the sides of the exterior support structure may be from 13.5″ to 15.5″ with the “short” side being approximately ½ inch shorter than the long side.

FIGS. 4-6 are generally illustrated to scale. Thus, the baffle filter takes up greater than 50% of the thickness of the filter assembly. In various embodiments, the baffle filter may comprise 55% to 75% of such thickness. The exterior support structure and filter material together comprise less than ⅓ of the thickness. In various embodiments, the exterior support structure may comprise 15% to 40% of the thickness. In particular embodiments, the filter material (e.g., filter pad) may be slightly longer than the exterior support structure in at least one dimension to allow for the filter assembly to lap over the exterior support structure on at least two sides of the exterior support structure, and in some embodiments on all four sides.

In accordance with a particular embodiment, the rigidity provided by the exterior support structure may be advantageous for more easily handling the filter material during the installation and removal of the filter material, thereby shortening the time and effort required for installation and removal.

The first filter may be orientated with the external support element either on the upstream or downstream side of the filter material for aesthetics and maintenance purposes benefits.

The external support structure may not require any additional support on the opposite side of the filter material.

The first filter may be attached, such as removably attached, to the second filter.

The filter material of the first filter may be natural fibers, hybrid fibers, synthetic fibers or any combination thereof.

The second filters elements may cooperate to define an opening for the first filter.

The second filter may comprise: a housing, top lip, bottom lip, hanging clips, flame barrier, drain holes, middle divider tabs and a perforated air diffuser.

The flame barrier within the second filter may be one or more baffle filters, metal mesh filters or any other known flame barrier.

The ventilation hood may include a track, and the second filter may be configured to be inserted and possibly clipped onto the hood with the use of the filter assembly's hanging clips and be moved along the track. The first filter may also be configured to be inserted the second filter and into the hood by being moved along the track.

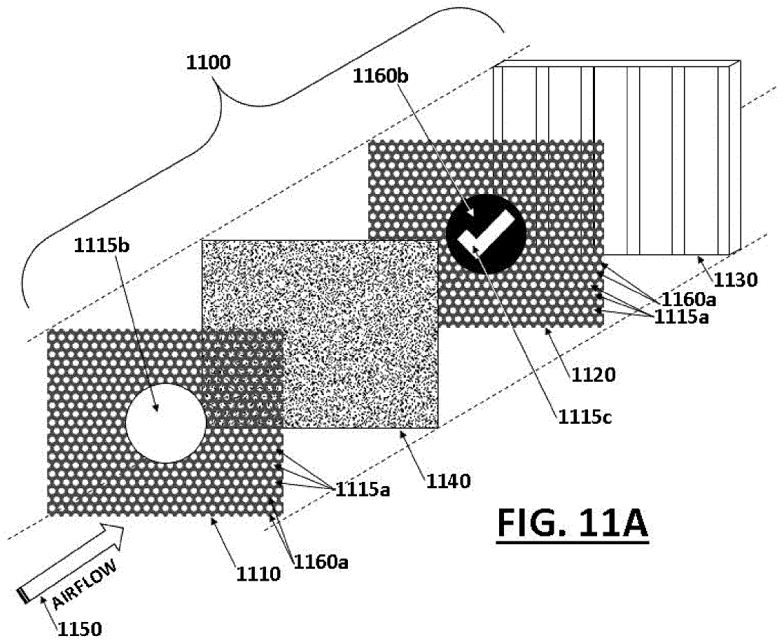

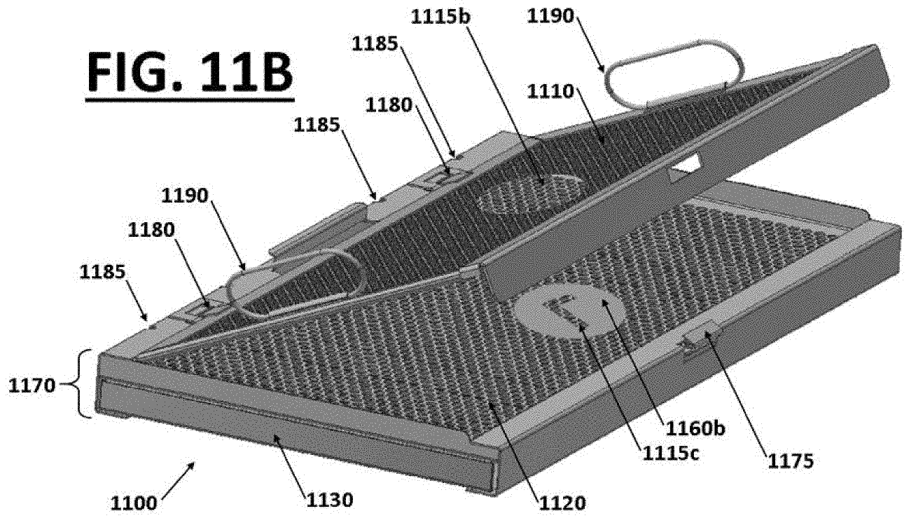

As described in Applicant's U.S. non-provisional application Ser. No. 14/304,765 (which, as stated above, is incorporated by reference), a filter assembly may be configured to provide a visual indicator for the useable life of an installed filter. In some embodiments, a filter assembly 1100 comprises one or more perforated inserts. For example, as depicted in FIGS. 11A and 11B, filter assembly 1100 includes a first perforated insert 1110 and a second perforated insert 1120. In some embodiments, filter assembly 1100 further includes a baffle assembly 1130. In some other embodiments, filter assembly 1100 includes a filter pad comprising filter material. The first perforated insert 1110 and the second perforated insert 1120 may cooperate to hold a disposable filter (e.g., filter material 1140) in a generally flat configuration. As described in Applicant's U.S. provisional application Ser. No. 61/835,383 (which, as stated above, is incorporated by reference), one or more components of FIG. 11A may be configured within a housing 1170 (also referred to herein as an “external frame assembly”). Filter assembly 1100 may be configured to be disposed within a ventilation hood within a kitchen. In some embodiments, filter assembly 1100 is installed in the ventilation hood such that perforated insert 1110 is upstream of baffle assembly 1130. In other embodiments, filter assembly 1000 is installed in the ventilation hood such that perforated insert 1110 is downstream of baffle assembly 1130. Housing 1170 may include one or more drain holes (apertures) 1185 along a bottom side of housing 1170. In some embodiments, housing 1170 includes one or more rows of drain holes 1185.

In some embodiments, baffle assembly 1130 may comprise one or more baffles. Some embodiments include an upstream row of vertical baffle ribs and a downstream row of vertical baffle ribs. In such embodiments, the upstream row of vertical baffle ribs may be offset from the downstream row of vertical baffle ribs in a way that defines an airflow spacing (see e.g., FIG. 4). Baffle assembly 1130 may be compliant with the UL Standard 1046. The thickness of baffle assembly may be between approximately 0.25″ to approximately 1.5.″ In some embodiments, the thickness of baffle assembly may be between approximately 0.5″ and 1.25″ or between a narrower range between approximately 0.6″ and 1.1″. As an example, the thickness of baffle assembly may be approximately 0.75″. Baffle assembly 1130 may comprise any suitable material such as stainless steel, carbon steel, aluminum, and/or galvanized metal. The thickness of such material may vary but may be between approximately 14-gauge to approximately 28-gauge or between a narrower range between approximately 18-gauge to 25-gauge. As an example, the thickness of the material may be 20-gauge. Although specific thicknesses and metals have been described in reference to baffle assembly 1130, this disclosure recognizes that baffle assembly 1130 may include any suitable thicknesses and metals. This disclosure also recognizes that baffle assembly 1130 may be substituted for one or more metal mesh filters (not depicted) in filter assembly 1100.

One or more perforated inserts (e.g., perforated insert 1110 and 1120) of filter assembly 1100 may be removably coupled to filter assembly 1100 to permit access to other components of filter assembly 1100. For example, as depicted in FIGS. 3-4, perforated insert 1110 may be configured to be slidably removed from filter assembly 1100. As another example, as depicted in FIG. 11B, perforated insert 1110 may be coupled to filter assembly 1100 by one or more hinges 1180. In some embodiments, perforated insert 1110 may lock shut when hinged. For example, such as depicted in FIG. 11B, perforated insert 1110 is locked shut using a compressible button 1175 positioned along housing 1170. In some embodiments, perforated insert 1110 remains locked shut unless and/or until unlocked through compression by a user (e.g., without the use of a key or tool). In some embodiments, one or more perforated inserts (e.g., perforated insert 1110 and 1120) of filter assembly 1100 include one or more handles 1190. As depicted in FIG. 11B, perforated insert 1110 includes handles 1190. This disclosure recognizes that handles 1190 may assist operators in the removal of perforated inserts (e.g., perforated insert 1110 and 1120).

Perforated inserts 1120, 1130 may be made of any suitable material. Preferably, perforated inserts 1120, 1130 are made of a non-flammable material such as stainless steel, carbon steel, aluminum, and/or galvanized metal. In some embodiments, perforated inserts 1120, 1130 comprise the same material (e.g., stainless steel). In other embodiments, perforated inserts 1120, 1130 comprise different materials (e.g., perforated insert 1120 comprises stainless steel and perforated insert 1130 comprises carbon steel). In some embodiments, perforated inserts 1120, 1130 have a thickness between approximately 14-gauge and 28-gauge. Perforated inserts 1120, 1130 may have the same and/or different thicknesses. For example, perforated inserts 1120, 1130 may both have a thickness of 19-gauge. As another example, perforated insert 1120 may have a thickness of 19-gauge and perforated insert 1130 may have a thickness of 20-gauge. Although this disclosure describes perforated inserts 1120, 1130 having particular thicknesses, this disclosure recognizes that perforated inserts 1120, 1130 may have any suitable thickness. Preferably, perforated inserts 1120, 1130 are only as thick as necessary given that a thicker piece of metal tends to weigh more than a thinner piece of metal.

In some embodiments, perforated inserts 1120, 1130 may comprise one or more perforations 1115. Perforations 1115 may permit airflow therethrough. As indicated by the arrow 1150 of FIG. 11, air may first flow through perforated insert 1110 (via perforations 1115), and thereafter flow through filter material 1140, perforated insert 1120 (via perforations 1115), and baffle assembly 1130 (via airflow spacing 407 of FIG. 5). As recognized herein, air may continue to flow through a ventilation duct after traveling through filter assembly 1100. In some embodiments, the shape of perforations 1115 are one or more of: round, square, ovular, slotted, lattice, hanover square, moire, and/or honeycomb. As depicted in FIG. 11, all perforations 1115 are round. In other embodiments, perforations 1115 of one perforated insert (e.g., perforated insert 1120) may be two or more shapes (e.g., square and ovular) whereas perforations 1115 of another perforated insert (e.g., perforated insert 1130) may be one shape (e.g., lattice). The size of perforations 1115 of perforated inserts may also vary. In some embodiments, perforation size may range between approximately 0.02″ and approximately 1″. In other embodiments, the size of perforations 1115 may be between a narrower range of approximately 0.2″ and approximately 0.5″. As an example, perforations 1115 may be 0.25″. Although this disclosure describes and depicts particular configurations of perforations 1115, this disclosure recognizes that perforations 1115 may be of any suitable size and shape that may, in some embodiments, be stamped out of the grating.

Perforated inserts (e.g., perforated insert 1110 and 1120) may have defined spacing between perforations 1115. In some embodiments, perforations 1115 of one or more of perforated inserts 1120, 1130 are spaced between 7/64″ (0.109375 inches) and 1⅜″ (1.375 inches) apart. Other embodiments may space perforations between a narrower range of 5/32″ and ½″. As an example, spacing between perforations may be 5/16″. Perforations 1115 of perforated inserts (e.g., perforated insert 1110 and 1120) may also have a particular alignment. For example, as depicted in FIG. 1100, perforations 1115 in each row may be aligned in a straight pattern. As another example, perforations 1115 in each row may be aligned in a staggered pattern. In some embodiments, perforated inserts (e.g., perforated insert 1110 and 1120) having a staggered pattern are staggered at a 60° angle from a center perforation. In other embodiments, perforated inserts (e.g., perforated insert 1110 and 1120) having a staggered pattern are staggered at a 45° angle from a center perforation. Additionally, perforated insert (e.g., perforated insert 1110 and 1120) may have a closed hem edge such that edges of perforated insert are smooth (see e.g., exterior support structure 300 of FIG. 9). Other embodiments may have perforations extending to the edges for extra rigidity (i.e., u-shaped perimeter frame) (see e.g., perforated inserts 1110 and 1120 of FIG. 11).

Perforated inserts (e.g., perforated insert 1110 and 1120) may vary in percent openness. As used herein, percent openness refers to the percentage of open area of perforated insert. For example, a perforated insert having 0.250″ hole diameter, 5/16″ from a center perforation, and staggered at 60° may have a percent openness of 58%. As another example, a having 0.188″ hole diameter, 7/32″ from a center perforation, and staggered at 60° may have a percent openness of 66%. This disclosure recognizes that perforated insert (e.g., perforated insert 1110 and 1120) may have any suitable percent openness. As will be explained in more detail below, perforated inserts may have one or more perforations 1160 of any suitable size and shape and these perforations 1160 may affect the percent openness. Perforated inserts of a filter assembly (e.g., filter assembly 1100) may have different percent openness. For example, perforated insert 1110 may have a percent openness between approximately 58% to approximately 90% or between a narrower range between approximately 65% and approximately 80%. As an example, perforated insert 1110 may have a percent openness of approximately 70%. In some embodiments, perforated insert 1120 may have a percent openness between approximately 40% to approximately 66% or between a narrower range between approximately 45% to approximately 55%. As an example, perforated inert 1120 may have a percent openness of 52%.

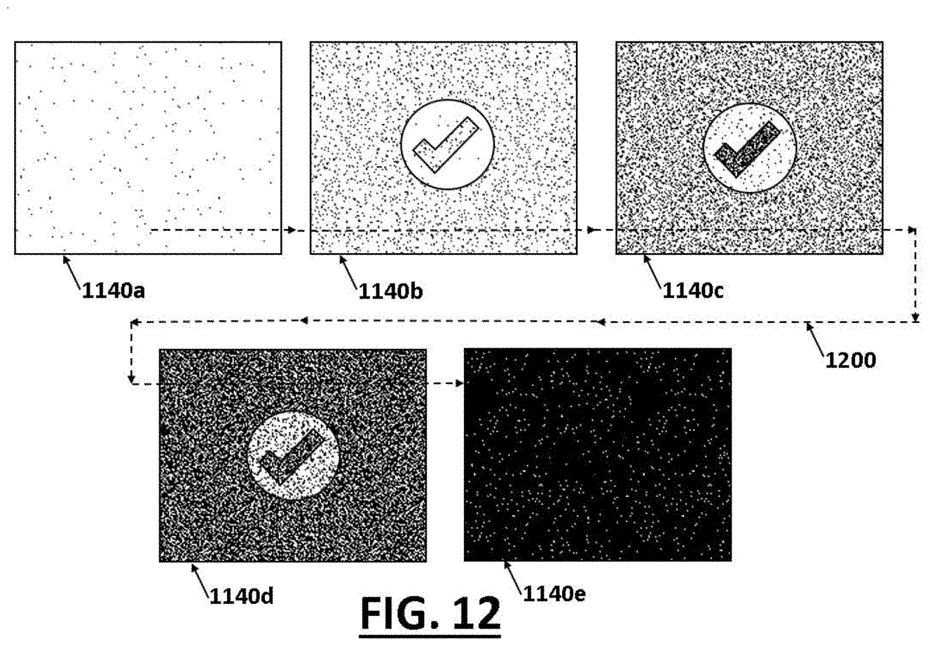

This disclosure recognizes that standard, unmodified perforated metal maintaining a generally rigid construction and having round perforations has a maximum percent openness of approximately 66% due to size, spacing and alignment options of the perforations. Although the percent openness of standard perforated metal may be sufficient when used in some applications, such standard perforated metal is insufficient in other applications. As an example, the percent openness of standard perforated metal is insufficient in applications where it is a necessity to reduce as much airflow resistance as possible. An advantage of the perforated inserts (e.g., perforated inserts 1110, 1120, and 1310) disclosed herein is that they are uniquely configured to increase the percent openness of standard, unmodified perforated metal by approximately 30%. As an example, this disclosure recognizes increasing the percent opening of a standard, unmodified perforated metal maintaining a rigid construction and having round perforations by manufacturing a perforated insert to include at least one larger perforation (e.g., perforation 1115b of perforated insert 1110 and/or perforation 1115c of perforated insert 11120) in addition to the plurality of standard perforations (e.g., perforations 1115a) which are commonly present in standard, unmodified perforated metal. Including such larger perforation(s) may increase the percent openness of standard, unmodified perforated metal maintaining a rigid construction and having round perforations from approximately 66% to approximately 85%, without modifying the size, spacing and/or alignment of the standard perforations (e.g., perforations 1115a). As described in more detail below, these larger perforations may, in some cases, permit more air to flow therethrough and/or provide a viewport permitting an unobstructed view of a portion of filter material 1140. In some embodiments, the viewport is established by a perforation 1115 of perforated insert 1110. For example, perforation 1115b may provide a viewport allowing the viewing of a visual indicator (e.g., check mark of FIG. 12) that appears on one or more surfaces of filter material 1140 as filter material 1140 collects airborne particulates.

As depicted in FIG. 1100, perforated inserts (e.g., perforated insert 1110 and 1120) may include perforations 1115. In some embodiments, perforations 1115 may be the same size throughout (see e.g., downstream perforated air diffuser 409 and/or exterior support structure 300 of FIG. 9). In other embodiments, one or more perforations 1115 may be one size and one or more perforations 1115 may be a different size. As an example, perforated insert 1110 includes perforations 1115a and 1115b. As another example, perforated insert 1120 includes perforations 1115a and 1115c. Perforation 1115b and/or 1115c may be of any suitable shape and size and may be positioned at any suitable location on perforated insert 1110 and/or 1120. Perforation 1115b of perforated insert 1110 may be considered a viewport because, in some embodiments, it provides an unobstructed view to filter material 1140.

Perforated inserts 1110 and 1120 also include non-perforated portions 1160. Non-perforated portions 1160 may, in some embodiments, include all portions of perforated inserts 1110 and 1120 without perforations 1115. As disclosed in FIG. 11, perforated insert 1110 includes non-perforated portions 1160a and perforated insert 1120 includes non-perforated portions 1160a and non-perforated portions 1160b. As illustrated in FIG. 11, non-perforated portions 1160 can vary in size and shape. For example, the area of non-perforated portion 1160b is larger and shaped differently than non-perforated portions 1160a. As a result, non-perforated portion 1160b provides a higher airflow resistance than that provided by non-perforated portion 1160a.

In some embodiments, perforated inserts 1110 and 1120 are configured to cooperate with filter pad 1140 such that air containing airborne particulates flows through perforated inserts 1110, 1120 in a manner that reveals a visual indicator. As will be described in more detail below, visual indicator may be any suitable size and shape. As illustrated in FIG. 12, the visual indicator is a check mark. A visual indicator may reveal itself over time due to the manner in which filter pad 1140 collects (also referred to herein as “loads”) airborne particulates (e.g., grease). This may be possible because, as explained in U.S. patent application Ser. No. 14/304,765 (incorporated by reference herein), airflow takes the path of least resistance. As such, air flow 1150 is able to flow through perforations 1115 and air flow 1150 is restricted from flowing through non-perforated portions 1160. Because air flow 1150 is restricted from flowing at non-perforated portions 1160, filter material 1140 may generally accumulate airborne particulates first in areas having little to no resistance before accumulating in areas having restricted airflow. Taking FIG. 11A as an example, airflow 1150 freely flows through perforations 1115a-c of perforated inserts 1110 and 1120 but airflow 1150 is generally restricted due to non-perforated portions 1160. As such, filter material 1140 will generally load airborne particulates in the pattern formed by perforations 1115 and non-perforated portions 1160. As illustrated in FIG. 12, the pattern formed by perforations 1115 and non-perforated portions 1160 of perforated inserts 1110 and 1120 causes filter material 1140 to load particulates in a manner that reveals a check mark.

This disclosure recognizes that the size and/or shape of non-perforated portions 1160 may affect the loading of filter material 1140. For example, the area of non-perforated portions 1160a of perforated inserts 1110 and 1120 may not be large enough to delay grease from loading on the portion of filter material 1140 directly abutting non-perforated portions 1160a. Comparatively, the area of non-perforated portion 1160b of non-perforated insert 1120 may be large enough to delay grease from loading on the portion of filter material 1140 directly abutting non-perforated portions 1160b.

FIG. 12 illustrates an example of a life cycle 1200 of filter material 1140 when disposed between perforated inserts 1110 and 1120 of filter assembly 1100. Filter material 1140 may progress through a series of stages from about 0% loaded (not depicted) to about 100% loaded (not depicted). The filter life stages between about 0% loaded to about 100% loaded are depicted in FIG. 12. Airborne particulate collection is indicated in FIG. 12 using black shading. For example, filter material 1140a is exemplary of filter material 1140 shortly after it has begun collecting airborne particulates. Filter material 1140b is exemplary of filter material 1140 that is about 25% loaded (or stated differently, filter material 1140 having about 75% life left). Filter material 1140c is exemplary of filter material 1140 that is about 50% loaded (or stated differently, filter material 1140 having about 50% life left). Filter material 1140d is exemplary of filter material 1140 that is about 75% loaded (or stated differently, filter material 1140 having about 25% life left). Finally, filter material 1140e is exemplary of filter material that is about 98% loaded (or stated differently, filter material 1140 having about 2% life left). The percentages provided in the above paragraph are exemplary and not meant to be an exact representation of the loading level of filter material 1140.

As depicted in FIG. 12, filter material 1140 generally loads airborne particulates (e.g., grease) first in areas of little to no airflow restriction and, as the density of airborne particulates increases in these areas over time, filter material 1140 begins to load airborne particulates in areas having more restricted airflow. As described above, restriction of airflow 1150 may be caused by the non-perforated portions 1160 of one or more perforated inserts (e.g., perforated insert 1110 and/or perforated insert 1120). As a result of this loading process, filter life is able to be visually indicated. For example, as illustrated in FIG. 12, a visual indicator (e.g., check mark) is revealed during the life cycle of filter material 1140. A person responsible for changing filter material 1140 (e.g., an operator) may identify, by the presence of absence of the visual indicator, when filter material 1140 should be discarded and/or replaced. For example, an operator may know that it is close to time (or time) to discard/replace filter material 1140 when visual indicator has disappeared (see e.g., filter material 1140e). Thus, the visual indicator may indicate the particulate collection level within filter pad 1140 by a change in a contrasting pattern and density of particulate collection on a surface of filter pad 1140 during the life cycle of filter pad 1140. As stated above, filter pad 1140 may have a uniform color density across the entire surface of filter pad 1140 at the end of its life cycle. This change in color density and pattern may be easily recognizable, thus making it also suitable for use by individuals who are color blind.

Although this disclosure depicts visual indicator as a check mark in FIG. 12, this disclosure recognizes that visual indicator may be any suitable contrasting pattern such as shapes, text (e.g., alphanumeric characters), and/or symbols. As described and depicted in Applicant's U.S. non-provisional application Ser. No. 14/304,765, visual indicator may be one or more vertical and/or horizontal strips. Visual indicators, irrespective of the pattern, serve to visually indicate the filter life of filter material 1140.

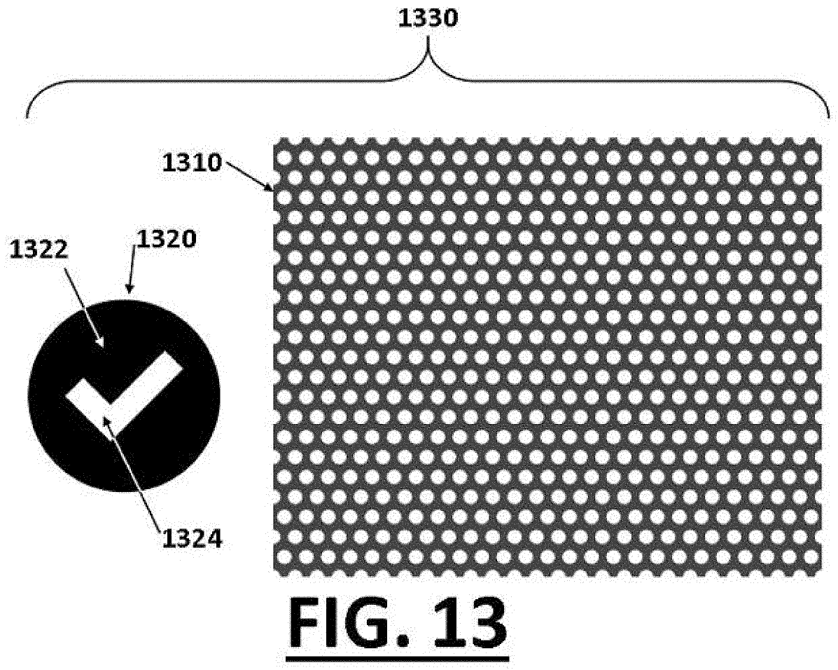

As described above, visual indicators may result due to the perforations 1115 and non-perforated portions 1160 of one or more perforated inserts (e.g., perforated insert 1110 and/or perforated insert 1120) in some embodiments. In other embodiments, filter life may be indicated in other ways. For example, as depicted in FIG. 13, a decal 1320 may be positioned on perforated insert 1310 to form a decal assembly 1330. In some embodiments, perforated insert 1310 may be perforated insert 1110 or perforated insert 1120 of filter assembly 1100. Decal 1320 may include one or more solid portions 1322 and one or more perforations 1324. As depicted in FIG. 13, decal 1320 includes one perforation 1324 in the shape of a check mark surrounded by solid portion 1322. Decal 1320 may be positioned at any suitable location on perforated insert 1310. In some embodiments, decal 1320 may be coupled to perforated insert 1310. Decal 1320 may be made of any suitable material, including but not limited to paper, plastic, metal. In some embodiments, decal 1320 is coupled to perforated insert 1310 by adhesive. In other embodiments, decal 1320 is coupled to perforated insert 1310 by welding. Decal assembly 1330 may be used in substitution of one or more perforated inserts of filter assembly 1100. For example, perforated insert 1120 may be substituted for decal assembly 1330 in filter assembly 1100. In operation, the solid portions 1322 of decal 1320 restrict air flow such that filter material 1140 loads in a similar manner to that described in reference to FIG. 12.

Although not depicted, this disclosure also recognizes that decal 1320 may be positioned on a surface of filter material 1140 (e.g., upstream or downstream surface). In some embodiments, decal 1320 is coupled to filter material 1140 using adhesive or other suitable alternative. In other embodiments, decal 1320 is not coupled to filter material 1140 but is instead held substantially in place by the compression of perforated inserts (e.g., perforated inserts 1110 and 1120) of filter assembly 1100. This disclosure contemplates that perforated inserts (e.g., perforated inserts 1110, 1120, 1310) used in conjunction with decals 1320 may be any suitable size and shape and include perforations 1115 and non-perforated portions 1160 of any suitable size and shape. This disclosure also recognizes certain benefits of perforated inserts having perforations 1115 of particular sizes and shapes in embodiments having decals 1320. For example, this disclosure recognizes airflow benefits of embodiments having perforated inserts with perforations 1115 of substantially the same size and shape of decals 1320 and positioned such that perforations 1115 and decals 1320 substantially line up. In such case, air flows freely through perforations 1115 of perforated insert (e.g., perforated insert 1110, 1120, 1310) and is only restricted generally at solid portions 1322 of decal 1320.

As described above, filter material 1140 may be disposed between first perforated insert 1110 and second perforated insert 1120. In some embodiments, filter material 1140 comprises fibers. Filter material may comprise one or more of natural fibers, synthetic fibers, and/or hybrid fibers. Natural fibers may include one or more of plant fibers and/or animal fibers such as kapok, luffa, abaca, coir, cotton, flax, hemp, jute, ramie, sisal, alpaca, angora, camel, cashmere, mohair, silk, linen, manila, wool. Synthetic fibers may one or more of nylon, acrylic, polyethylene, cellulose, rubber, lyocell, triacetate, rayon, acetate, acrylic, polyester, polypropylene, and polyolefin. Hybrid fibers may include those fibers that are derived from nature but are materially modified by man. An example of a hybrid fiber may be viscose, rayon, PLA, PLA flame resistant polymers, biodegradable flame-resistant polymers, flame resistant rayon, synthetic fiber derived from a natural source, and fibers that are derived from corn starch.

In some embodiments, filter material 1140 comprises approximately equal percentages of two types of fibers. As an example, filter material 1140 may comprise approximately 50% natural fibers (e.g., wool fibers) and 50% hybrid fibers (e.g., viscose fibers). In other embodiments, filter material 1140 comprises approximately equal percentages of natural, synthetic, and hybrid fibers (e.g., 33.33% natural fibers, 33.33% hybrid fibers, and 33.33% synthetic fibers). In yet other embodiments, fiber material 1140 comprises fibers of only a single type (e.g., 100% natural fibers, 100% synthetic fibers, 100% hybrid fibers).

This disclosure also recognizes that filter material 1140 may have particular fiber blend compositions. In some embodiments, filter material 1140 may include approximately 0.1%-45% natural and/or synthetic fibers and approximately 55%-99.9% hybrid fibers. As an example, filter material 1140 may comprise approximately 55% viscose fibers and approximately 45% wool fibers. As another example, filter material 1140 may comprise approximately 65% viscose fibers and approximately 35% wool fibers. In other embodiments, filter material 1140 may include approximately 0.1%-45% hybrid and/or synthetic fibers and approximately 55%-99% natural fibers. As an example, filter material 1140 may comprise 20% viscose fibers and 80% wool fibers. As another example, filter material 1140 may comprise 5% viscose fibers and 95% wool fibers. In yet other embodiments, filter material 1140 may include approximately 0.1%-45% natural and/or hybrid fibers and approximately 55%-95% synthetic fibers. For example, filter material 1140 may comprise approximately 40% wool fibers, 5% viscose fibers, and 55% nylon fibers. As another example, filter material 1140 may comprise approximately 35% wool fibers, 10% viscose fibers, and 55% polyester fibers.

Fiber material 1140 may preferably comprise at least some oleophilic fibers such as wool, kapok, and/or luffa. Oleophilic fibers may be desirable because of their oil affinity characteristic. This disclosure recognizes that oleophilic fibers may be more effective at capturing and/or removing grease from grease-laden vapor or air emanating from kitchen equipment relative to non-oleophilic fibers. In some embodiments, fibers of fiber material 1140 may have a linear density between approximately 2-9 denier. For example, fiber material 1140 may include one or more viscose fibers having a linear density between approximately 2-9 denier. In some embodiments, one or more viscose fibers are provided within a narrower range of approximately 4-8 denier. In particular embodiments, the linear density of one or more viscose fibers may be 5 denier. In some embodiments, at least some of the fibers of fiber material 1140 are treated with a fire resistant and/or a fire-retardant solution.

Although this disclosure describes and depicts filter assembly 1100 including one or more perforated inserts (e.g., perforated insert 1110 and 1120), this disclosure recognizes that perforated inserts of filter assembly 1100 may be substituted with other materials as well. For example, any grade of stainless steel, carbon steel, aluminum, galvanized metal or any other non-flammable material may be suitable alternatives for perforated inserts. Expanded metal (e.g., flattened, standard, architectural, custom fabricated) may be another suitable alternative for one or more perforated inserts. As used herein, a suitable alternative is preferably non-flammable and able to support filter material 1140. As described above relative to perforated inserts of filter assembly 1100, the alternative material may include a closed hem edge or a u-shaped perimeter frame. In some embodiments, the hole size in the alternative material is between about ⅛″ and 1½″ or between a narrower range of ¼″ to ¾″. As an example, the hole size in alternative material may be ½″. The overall thickness of the alternative material may be between approximately 14-gauge and approximately 28-gauge or a between a narrower range of approximately 18-gauge to 25-gauge. As an example, the thickness of the alternative material may be 20 gauge. The percent openness of the alternative material may be between approximately 36% and approximately 90% in some embodiments. In other embodiments, the percent openness of the alternative material is between a narrower range of approximately 50% to 80%. As an example, alternative material substituting perforated sheet 1110 may have a percent openness of 70%. In embodiments that do not include perforated metal sheets (i.e., sheets including perforations 1115a), the alternative material may still include perforations allowing air to flow therethrough (e.g., perforations 1115b and 1115c of FIG. 11A).

This disclosure describes and depicts a number of embodiments of filter assembly 1100. For example, as described above, filter assembly 1100 may include one or more perforated inserts (e.g., perforated inserts 1110 and 1120) and baffle assembly 1130. This disclosure also recognizes that filter assembly 1100 may comprise at least one perforated inserts (e.g., perforated inserts 1110 and 1120) and filter material 1140. In such case, the at least one perforated insert is configured to support filter material 1140 in a generally flat configuration. As such, filter material 1140 may be coupled to the at least one perforated insert (e.g., with adhesive). As described above, filter material may load airborne particulates in a manner that reveals a visual indicator. In some embodiments, the visual indicator is revealed due to the configuration of perforations 1115 and non-perforated portions 1160 of the perforated insert. In other embodiments, the visual indicator is revealed due to the configuration of perforations 1324 and solid portions 1322 of decal 1322. As explained above, decal 1322 may be positioned and/or coupled to either the perforated insert or the filter material 1140.

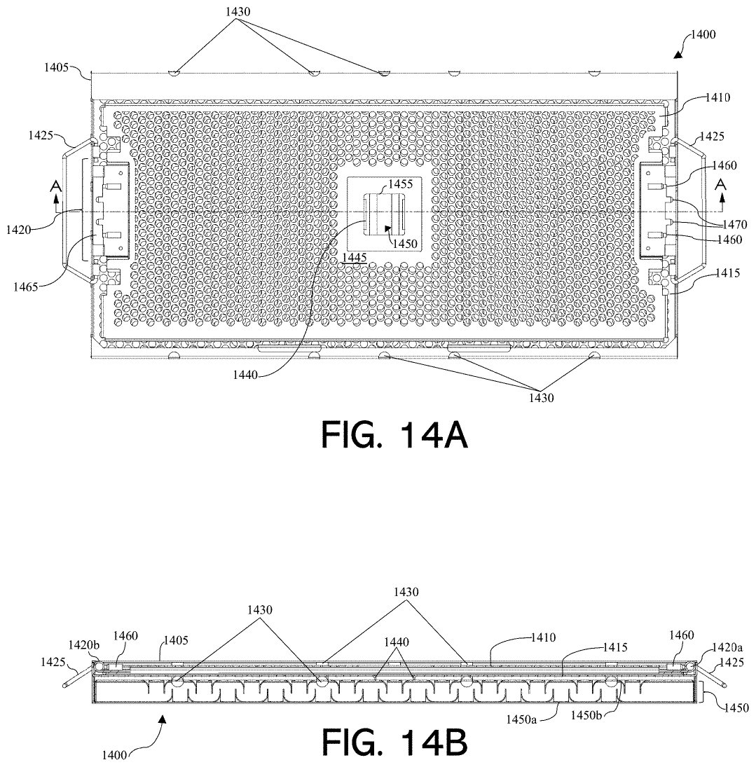

FIG. 14A illustrates an exemplary grease filter 1400. FIG. 14B illustrates a cross section of grease filter 1400 taken along the plane indicated by broken line A of FIG. 14A. As illustrated, grease filter 1400 comprises an external frame 1405, a first housing element 1410, a second housing element 1420, and a baffle assembly 1450. Baffle assembly 1450 may comprise one or more rows of baffle ribs that may feature or comprise one or more of the baffle-related characteristics described above with respect FIGS. 4, 11A and 11B. FIG. 14A depicts baffle assembly 1450 comprising two rows of baffle ribs 1450a & 1450b. In some embodiments, baffle assembly 1450 is identical to baffle assembly 1130. In some embodiments, housing elements 1410 & 1415 are perforated metal sheets comprising a plurality of perforations therethrough. Housing elements 1410 & 1415 may feature or comprise one or more of the characteristics described above with respect to perforated inserts 1110, 1120, 1310. For example, housing elements 1410 & 1415 may have perforations spaced between 7/64″ (0.109375 inches) and 1⅜″ (1.375 inches) apart. The perforations within housing elements 1410 & 1415 may at least partially define one or more non-perforated portions of housing elements 1410 & 1415. To the extent there are any, the perforated portions of housing elements 1410 & 1415 permit air to flow therethrough and the one or more non-perforated portions restrict air from flowing therethrough.

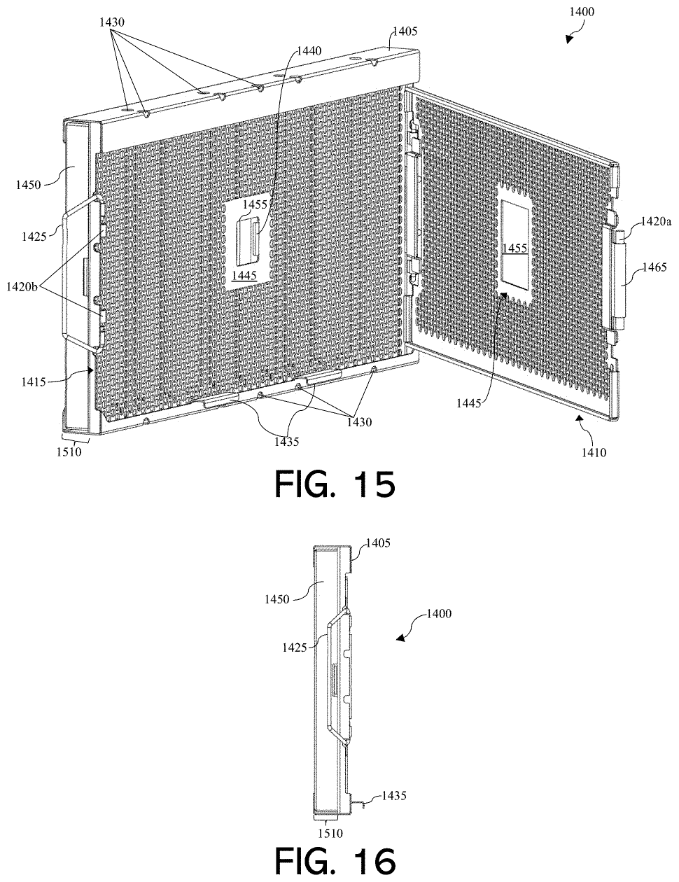

Housing elements 1410 & 1415 may optionally have one or more viewports 1455. Viewports 1455 are apertures within housing elements 1410 & 1415 that are surrounded by non-perforated regions 1445. As illustrated in FIGS. 14-15 & 17, viewports 1455 are larger in size than other apertures within housing elements 1410 & 1415. In some embodiments, non-perforated region 1445 of second housing element is in at least partial alignment with viewport 1455 of first housing element 1410. For example, as illustrated in FIGS. 14A and 15, at least a portion of viewport 1455 of first housing element 1410 overlaps with at least a portion of non-perforated region 1445 of second housing element. This alignment or overlap between viewport 1455 of first housing element 1410 and non-perforated region 1445 of second housing element may facilitate the appearance of a filter life indicator on a filter pad (e.g., filter pad 1710).

External frame 1405 is a housing for one or more subcomponents of grease filter 1400. Subcomponents (e.g., one or more housing elements 1410 & 1420, baffle assembly 1450) of grease filter 1400 may or may not be permanently affixed within external frame 1405. In some embodiments, one subcomponent is permanently affixed to external frame 1405 while the others are removably secured to external frame 1405. For example, second housing element 1420 may be permanently affixed to external frame 1405 and first housing element 1410 and baffle assembly 1450 may be removably secured to external frame 1405.

External frame 1405 may optionally include one or more drain holes 1430. Drain holes 1430 may be positioned along an edge of external frame 1405 and be configured to permit grease droplets to exit grease filter 1400. As shown in FIGS. 14, 15 and 17, drain holes 1430 are positioned along a top edge and bottom edge of external frame 1405. Positioning drain holes 1430 along both the top and bottom edges of external frame 1405 may be advantageous in circumstances wherein grease filter 1400 is installed upside down within an exhaust hood (i.e., installed with top edge of external frame 1405 abutting a bottom channel of exhaust hood and bottom edge of external frame 1405 abutting a top channel of exhaust hood rather than vice versa). In some embodiments, grease filter 1400 includes two sets of drain holes 1430. A first set may be positioned along a downstream portion of grease filter 1400 and a second set may be positioned along an upstream portion of grease filter 1400. The first set of drain holes 1430 may be configured to provide an exit path for grease droplets collecting in baffle assembly 1450 and the second set of drain holes 1430 may be configured to provide an exit path for grease droplets collecting along housing units 1410 & 1415.

Although many conventional exhaust hoods include a top channel and a bottom channel with which grease filter 1400 may be configured to fit within, some conventional exhaust hoods do not. Accordingly, this disclosure recognizes embodiments of grease filter 1400 which further include one or more hood clips 1435 configured to engage an opening of the exhaust hood to provide support for grease filter 1400 within the exhaust hood. In some embodiments, hood clips 1435 are positioned along a bottom edge of external frame 1405.

Like the grease filter illustrated in other figures herein, grease filter 1400 may include one or more handles 1425. Handle(s) 1425 may be permanently or removably attached to any suitable subcomponent of grease filter 1400. For example, handle 1425 may be coupled to external frame 1405, first housing unit 1410, or second housing unit 1415. Grease filter 1400 may also include one or more divider tabs 1440. As illustrated in FIGS. 14-15, divider tab(s) 1440 may be positioned between baffle assembly 1450 and second housing unit 1415. In some embodiments, divider tab(s) 1440 are configured to hold the second housing element 1415 in spaced relation from baffle assembly 1450. One reason for doing so is to distribute the air that would otherwise only flow through ribs of baffle assembly 1450. Although not depicted, this disclosure recognizes the use of divider tab(s) 1440 in other suitable positions as well. For example, grease filter 1400 may also include divider tab(s) positioned between second housing unit 1415 and, when installed within grease filter 1400, a filter pad.

As shown in FIG. 15, baffle assembly 1450 may be removably installed within a channel 1510 of external frame 1405. In some embodiments, baffle assembly 1450 slidably engages channel 1510. In other embodiments, baffle assembly 1450 snaps into channel 1510. Although this disclosure recognizes certain manners of removably installing baffle assembly 1450 within external frame 1405, this disclosure contemplates that baffle assembly 1450 may be removably installed within external frame 1405 in any suitable manner.

As described above, first housing element 1410 may also be removably secured to external frame 1405. FIGS. 14-16 illustrate removably securing first housing element 1410 to external frame 1405 with two coupling devices 1420. Although this disclosure specifically depicts and describes utilizing two coupling devices 1420 to removably secure first housing element 1410 to external frame 1405, this disclosure contemplates removably securing first housing element 1410 to external frame 1405 using any suitable number of coupling devices 1420 (e.g., one, two, three, etc.). Each coupling device 1420 illustrated in FIGS. 14-16 comprises a hinge pin 1420a and at least one hinge barrel 1420b. As will be understood by one of ordinary skill in the art, hinge pin 1420a may be threaded through at least one hinge barrel 1420b. In some embodiments, such as those illustrated in FIGS. 14-16, hinge pin(s) 1420a are permanently or removably coupled to first housing element 1410 and hinge barrel(s) are permanently or removably coupled to external frame 1405.

Hinge pin 1420a may be configured to expand in size from a compressed position to an elongated position. In some embodiments, the resting position for hinge pin 1420a is a compressed position; in other embodiments, such as those illustrated in FIGS. 14-16, the resting position for hinge pin 1420a is the elongated position. As used herein, a “compressed” position is any position wherein hinge pin 1420a is shorter than a height of hinge pin 1420a when in the elongated position. Hinge pin 1420a may be configured to expand or shorten based on pressure applied to one or more hinge levers 1460 (which may or may not be a subcomponent of coupling device 1420). As will be understood by one of ordinary skill in the art, compression of hinge lever(s) 1460 may result in the shortening of hinge pin 1420a to a compressed position. When in a compressed position, hinge pin 1420a may be freed (or otherwise released) from hinge barrel 1420b. In some embodiments, freeing hinge pin 1420a from hinge barrel(s) 1420b results in full detachment of first housing element 1410 from external frame 1405. In other embodiments, freeing hinge pin 1420a from hinge barrel(s) 1420b results in partial detachment of first housing element 1410 from external frame 1405. Partial detachment may permit first housing element 1410 to swing open in a door-like manner relative to other components of grease filter 1400.

As illustrated in FIGS. 14A, 14B, 15 and 17, hinge pin 1420a may extend through a pin stabilizer 1420c which may, in some embodiments, be affixed (temporarily or permanently) to first housing element 1410. Pin stabilizer 1420c is configured to accommodate hinge pin therethrough and includes, in some embodiments, locking rivets 1465 configured to accommodate hinge levers 1460. Each hinge lever 1460 may be configured to rotate laterally about hinge pin 1420a to engage a locking rivet 1465. When engaged with a locking rivet 1465, hinge pin 1420a is temporarily fixed in either the elongated position or a compressed position. As shown in FIGS. 14A, 14B, 15 and 17, hinge pin 1420a is temporarily fixed in an at least partially compressed position when one or more hinge levers 1460 engage a locking rivet 1465.

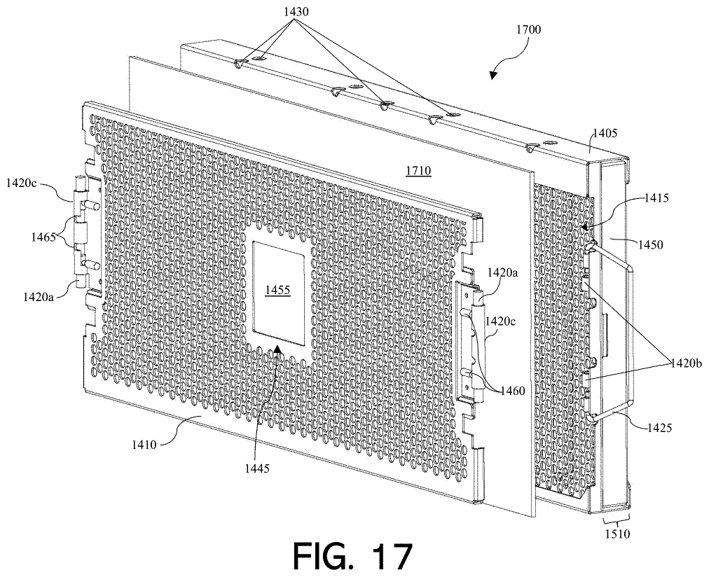

FIG. 17 illustrates an exploded view of a grease filter assembly comprising grease filter 1400 and filter pad 1710. As shown in FIG. 17, filter pad 1710 may be installed between first housing element 1410 and second housing element 1415. Filter pad 1710 may be configured to absorb grease particulates. In some embodiments, filter pad 1710 comprises wool and/or viscose fibers. Filter pad 1710 may be the same or similar to the “filter material” described above.

This disclosure recognizes certain benefits of containing all subcomponents of a grease filter within external frame 1405. As one example, grease filter 1400 and/or grease filter assembly 1700 may be assembled by an operator prior to installation within an exhaust hood. As filters typically are installed in exhaust hoods above cooking appliances where heat and flame occur, it is desirable to limit the amount of time an operator spends suspended above such appliances. Conventional multi-stage filters generally are installed component-by-component within exhaust hood making installation of such filters time consuming and dangerous. Embodiments described herein comprise components which may be removably installed from external frame 1400, making grease filter 1400 and/or grease filter assembly 1700 particularly easy to clean. For example, as described above, baffle assembly 1450 and first housing element 1410 may be removed from grease filter 1400 such that an operator can easily access and clean second housing element 1415 in addition to baffle assembly 1450 and first housing element 1410. Accordingly, the various embodiments disclosed herein are improvements over conventional multi-stage filters because they are easy and safe to assemble, install, and clean.

This disclosure makes several references to terms of approximation such as “about,” “approximately,” and/or “substantially.” Except as explicitly stated otherwise, terms of approximation are used to indicate a variance of 10% (i.e., +/−10%). For example, the use of the phrase “about 90%” may include values between 80% and 100%. As another example, the use of the phrase “approximately 14-gauge” may indicate within 10% of a metal thickness associated with 14-gauge (e.g., +/−10% of 1.984375 mm). As is understood by those of ordinary skill in the art, metal thickness is ordinarily measured in terms of a gauge and gauge thickness varies dependent on the type of metal being measured. For example, 18-gauge aluminum may be approximately 1.02 mm thick, whereas 18-gauge stainless steel may be approximately 1.27 mm thick and 18-gauge galvanized steel may be approximately 1.31 mm thick.

What is claimed is:

1. A grease filter for installation within an aperture of an exhaust hood overlying kitchen equipment where heat or flame may occur, the grease filter comprising:
an external frame comprising a plurality of drain holes and at least two hinge barrels, wherein the external frame defines a pathway for airflow therethrough and partially defines an upstream portion of the grease filter and a downstream portion of the grease filter;
a baffle filter disposed within the downstream portion of the grease filter, the baffle filter being secured within the external frame; and
a first housing element positioned within the upstream portion of the grease filter, the first housing element comprising a plurality of perforations, a viewport, and at least two coupling devices, wherein:
the first housing element is configured to provide support to a filter pad to maintain the filter pad in a generally flat configuration;
each coupling device comprises a hinge pin configured to engage at least one of the hinge barrels of the external frame; and
a second housing element disposed in series with the first housing element and positioned, within the external frame, adjacent to the baffle filter, the second housing element comprising a plurality of perforations and a non-perforated region, wherein:
the non-perforated region is in at least partial alignment with the viewport of the first housing element; and
the second housing element is held in spaced relation from the baffle filter by one or more divider tabs.

2. A grease filter comprising:
an external frame defining a pathway for airflow therethrough and partially defines an upstream portion of the grease filter and a downstream portion of the grease filter;
a first housing element disposed within the external frame, the first housing element comprising a viewport and at least one coupling device configured to engage one or more hinge barrels of the external frame; and
a second housing element disposed within the external frame and in series with the first housing element, the second housing element comprising a non-perforated region that is in at least partial alignment with the viewport of the first housing element.

3. The grease filter of claim 2, wherein the external frame comprises a plurality of drain holes.

4. The grease filter of claim 2, wherein the second housing element is one of a baffle filter or a perforated insert.

5. The grease filter of claim 2, further comprising a baffle filter disposed, within the external frame, at a position downstream the second housing element.

6. The grease filter of claim 2, further comprising a filter pad.

7. The grease filter of claim 2, the second housing element has a percent openness between 40% and 66%.

8. The grease filter of claim 2, wherein the first housing element and the second housing element cooperate to hold a filter pad in a generally flat configuration.

9. A grease filter comprising:
an external frame defining a pathway for airflow therethrough and partially defining an upstream portion of the grease filter and a downstream portion of the grease filter;
a baffle filter disposed within the downstream portion of the grease filter, the baffle filter being secured within the external frame; and
a first housing element positioned within the upstream portion of the grease filter, the first housing element being configured to provide support to a filter pad to maintain the filter pad in a generally flat configuration.

10. The grease filter of claim 9, wherein the filter pad, when installed, is disposed within the upstream portion of the grease filter adjacent to the first housing element.

11. The grease filter of claim 9, further comprising a second housing element disposed within the external frame between the baffle filter and the first housing element.

12. The grease filter of claim 11, wherein the second housing element is secured to one or more divider tabs of the external frame.

13. The grease filter of claim 9, wherein the baffle filter comprises at least first and second rows of baffles, the first and second rows of baffles being secured in staggered relation to each other.

14. The grease filter of claim 13, wherein each of the first and second rows of baffles include a plurality of baffles spaced apart from each other to provide openings therebetween for the flow of air therethrough.

15. The grease filter of claim 9, wherein the first housing element is a perforated insert.

16. The grease filter of claim 9, wherein the first housing element is a baffle filter comprising at least one row of baffles.

17. The grease filter of claim 9, wherein the first housing element is configured to move from a first position to a second position, the first position permitting installation of the filter pad within the grease filter and the second position not permitting installation of the filter pad within the grease filter.

18. The grease filter of claim 9, wherein the filter pad comprises a first fibrous mat coupled to a second fibrous mat.

19. The grease filter of claim 9, wherein the first housing element is coupled to the external frame via a hinge mechanism.

20. The grease filter of claim 9, wherein one or more handles are pivotally connected to the grease filter.
